(19) United States
(12) Patent Application Publication
(10) Pub. No.: US 2016/0175842 A1
(43) Pub. Date: Jun. 23, 2016

(54) Device for Introducing a Liquid Sample into a Microfluidic System

(71) Applicant: ROBERT BOSCH GMBH, Stuttgart (DE)

(72) Inventors: Lars Sodan, Balingen (DE); Holger Behrens, Stuttgart (DE)

(21) Appl. No.: 14/910,700

(22) PCT Filed: Jul. 24, 2014
(86) PCT No.: PCT/EP2014/065869

§ 371 Date: Feb. 6, 2016

(30) Foreign Application Priority Data
Aug. 7, 2013 (DE) 10 2013 215 565.4

(51) Int. Cl. B01L 3/00

(52) U.S. Cl. CPC B01L 3/563; B01L 2200/027; B01L 2300/0672; B01L 2400/0487

(57) ABSTRACT

A device for introducing a liquid sample into a microfluidic system includes an adapter component that is configured to be fluidically coupled to the microfluidic system via at least one channel. The adapter component has a receiving section that is configured to guide and accommodate a sample container. The receiving section positions the sample container in a first predetermined receiving position via a boundary element after the sample container is introduced into the receiving section. Starting from the first predetermined receiving position, the sample container is conveyed to a second predetermined receiving position within the receiving section. In the second predetermined receiving position, an opening element arranged below the receiving section in the adapter component penetrates the sample container such that the liquid sample of the sample container is configured to be conveyed to the at least one channel.

The present invention relates to a device for introducing a liquid sample into a microfluidic system which is intended in particular for fluidic connection to a diagnostic unit having a Lab-On-a-Chip (LOC) system.

### PRIOR ART

In the clinical analysis of patient samples for the presence of pathogens, use is increasingly being made of Lab-On-a-Chip (LOC) systems. These systems have to receive the patient sample and then process it within the LOC cartridge. In parallel therewith, there are variants in which a vial having the patient sample is placed in a single-use cartridge (without an LOC system), which is in turn fluidically coupled to a diagnostic unit having the LOC system. Here, the patient samples under consideration are intended in particular to be those which are in a liquid form, for example as a solution in the case of sputum and lavage, as a urine sample, or are present in what are known as blood collection tubes in the case of blood samples.

The patient sample should be filled into the cartridge with as little loss of the sample or contamination of the lab as possible. In the case of the liquid solutions, this has hitherto been carried out especially by pipetting into an opening in the cartridge. In the case of blood samples, the blood collection tube is frequently decanted or emptied by way of a syringe. The contents of the syringe are then filled into the cartridge. Thus, WO 2011/049718 discloses the input of the liquid blood into the input port. Disadvantages here are the great manual effort for decanting the sample and the possible risk of a mix-up or of the medical personnel coming into contact with the liquid sample during decanting.

### Advantages of the Invention

The device defined in claim 1 for introducing a liquid sample into a microfluidic system has the advantage that the various manual steps that have hitherto been necessary for transferring a liquid sample into the cartridge according to the prior art, in order to transfer the patient sample from the blood collection tube into the cartridge, can now be dispensed with. In this connection, the risk of contamination of the lab by the patient sample is likewise advantageously dispensed with, and the previously possible errors in sample assignment are additionally ruled out.

The essence of the present invention resides in the realization of direct transfer of a liquid patient sample from the sample container into the cartridge for an LOC, wherein the sample container is first plugged directly into the cartridge, which is preferably designed as a disposable adapter component, and the liquid sample is subsequently removed from the inside of the sample container by an opening element of the cartridge, such that said liquid sample can be made available to the LOC for further processing. In particular, as a result of the formation of a receiving portion in the cartridge, said receiving portion realizing two predetermined defined receiving positions for the sample container during the insertion thereof, the present invention is now in the position of ensuring that the liquid sample is processed only after the cartridge has been loaded into the diagnostic instrument, compared with existing solutions in which the contents of the sample container are transferred into the duct system of the cartridge outside the diagnostic instrument. Therefore, in the existing solution, the liquid sample from the sample container is present in the cartridge before the cartridge is set into operation in the diagnostic instrument, with the result that at the start of operation, the initial state of the sample is undefined and this can result in errors during the procedure. To this end, the present adapter component has, in the region of the first predetermined receiving position, a delimiting element which forms a first stop in the direction of the opening element, wherein, in the first predetermined receiving position, the sample container is still intact, and so the liquid sample cannot yet be removed from the sample container at this time.

Preferably, in the present device, the liquid sample is removed from the sample container in the region of the septum thereof, as long as it has one. In principle, however, the liquid sample can be removed at any desired point with regard to the sample container, as long as the latter is suitable for this purpose.

According to a further configuration of the present device, the sample container can be transferred from the first predetermined receiving position to the second predetermined receiving position within the receiving portion with the aid of an external plunger. In this case, the external plunger is preferably arranged on the diagnostic unit and is actuated by an associated actuator of the diagnostic unit such that this relatively expensive subassembly does not have to be disposed of together with the disposable cartridge but is permanently available. The operator plugs the sample container into the receiving portion as far as the first predetermined receiving position, which is formed by the delimiting element in the manner of a stop, wherein the septum of the sample container is not yet pierced by the opening element, in this case in particular the hollow needles. Thus, the liquid sample from the sample container does not pass into the duct system of the cartridge prior to operation. If the cartridge is subsequently inserted into the diagnostic unit, the plunger pushes the sample container onto the opening element, the septum is pierced and the liquid sample can subsequently be transferred into the duct system of the cartridge.

According to a further configuration of the present device, the opening element can be formed in the manner of a hollow needle and the at least one duct is fluidically connected to a second hollow needle which is arranged at a distance from the first hollow needle. Subsequently, the liquid sample can then take place from the sample container by pumping the sample container dry or evacuating it within the cartridge during operation in the diagnostic unit, wherein the liquid sample can be extracted only as far as the level of the hollow needle tip in this way.

According to a further configuration of the present device, the sample container can be transferred from the first predetermined receiving position to the second predetermined receiving position within the receiving portion by rotation of the sample container. This type of transfer forms an alternative to the above-described transfer by means of an external plunger and can advantageously realize for example a bayonet closure which is formed by the sample container and the receiving portion. In this case, the operator first of all introduces the sample container manually into the cartridge as far as the first predetermined receiving position, then moves it in the direction of the opening element by (gently) pushing in the sample container in order to elastically deform the delimiting element, and the operator subsequently inserts it further into the receiving portion manually as far as the second predetermined receiving position by rotating the sample container.

According to a further configuration of the present device, the opening element can be formed such that it at least partially slits open the sample container while it is being transferred into the second predetermined receiving position. For this purpose, the opening element is preferably formed in the manner of a cutter which pierces the septum of the sample container and/or a region of the sample container with the aid of at least one blade, such that an opening for the liquid sample to the at least one duct of the adapter component is formed. Additionally, during the rotation of the sample container while the sample container is being transferred from the first predetermined receiving position to the second predetermined receiving position within the receiving portion, the opening element can act transversely to the thickness direction of the sample container, such that at least one linear opening in the sample container is created. In principle, the contour of the cutter for producing the opening in the sample container can be configured as desired. Alternatively, the opening in the sample container can be produced by means of punching.

According to a further configuration of the present device, the opening element can be formed integrally with a hollow needle. In this case, a particularly simple structure for the opening element is realized. Preferably, the tip of the hollow needle is then arranged above the top side of the opening element.

According to a further configuration of the present device, the integrally formed opening element can be arranged substantially congruently with the longitudinal axis of the receiving portion. In this way, the liquid sample can be transferred from the sample container in the present receiving portion both by means of the external plunger and by means of rotation from the first predetermined receiving position to the second predetermined receiving position within the receiving portion.

According to a further configuration of the present device, the opening element and the hollow needle can each be configured in a substantially rotationally symmetrical manner, and while the sample container is being transferred from the first predetermined receiving position to the second predetermined receiving position, first of all the hollow needle pierces the sample container and subsequently the opening element slits open the sample container. If the opening element, in this case for example in the form of a cutter, and the hollow needle are configured in a rotationally symmetrical manner, it is possible to keep the sample container in the receiving portion of the adapter component by means of a bayonet closure. In the process, the hollow needle pierces in particular the septum of the sample container centrally and subsequently the bayonet closure can be plugged into the receiving portion. By way of the engagement of the bayonet closure in the receiving portion, in particular after the first predetermined receiving position has been reached, the opening element cuts through the septum or the sample container and creates a second opening, i.e. in addition to the first opening which was formed initially by the action of the hollow needle.

According to a further configuration of the present device, a recess in the adapter component for receiving the liquid sample from the sample container can be formed in the region of the opening element, said recess being fluidically connected to the at least one duct. In this case, the recess acts as a reservoir in which the liquid sample collects after the sample container has been opened in order subsequently to be pumped via the at least one duct for processing in the diagnostic unit.

According to a further configuration of the present device, the liquid sample can be transferred from the sample container into the recess in the second predetermined receiving position by a gaseous medium being pumped through the hollow needle, with the result that the liquid sample is pushed out of the sample container through the opening created by the opening element and subsequently flows into the recess. Thus, the sample container is likewise pumped dry in that the septum or the sample container is pierced preferably by a hollow needle through which the gaseous medium, in this case preferably air, can be pumped into the inside of the sample container, while on account of the second opening, which has been brought about by the opening element, is available for the exit of the liquid sample. For this operation, it is obligatory that the septum in the sample container points in the direction of the opening element or of the underside of the sample container in order that the introduced air collects in the upper region of the sample container. If the air is now pumped through the hollow needle into the sample container, the liquid sample is pushed out through the second opening and flows into the recess in the cartridge, from which it can be pumped out again.

### BRIEF DESCRIPTION OF THE DRAWINGS

The present invention is explained with reference to the accompanying drawings, in which

FIG. 1 shows a sectional view of a device for introducing a liquid sample into a microfluidic system according to a first embodiment of the present invention, and

FIG. 2 shows a sectional view of a device for introducing a liquid sample into a microfluidic system according to a second embodiment of the present invention.

### EMBODIMENTS OF THE INVENTION

It should be noted that, with regard to the figures and the description, identical reference signs refer to identical or similar elements.

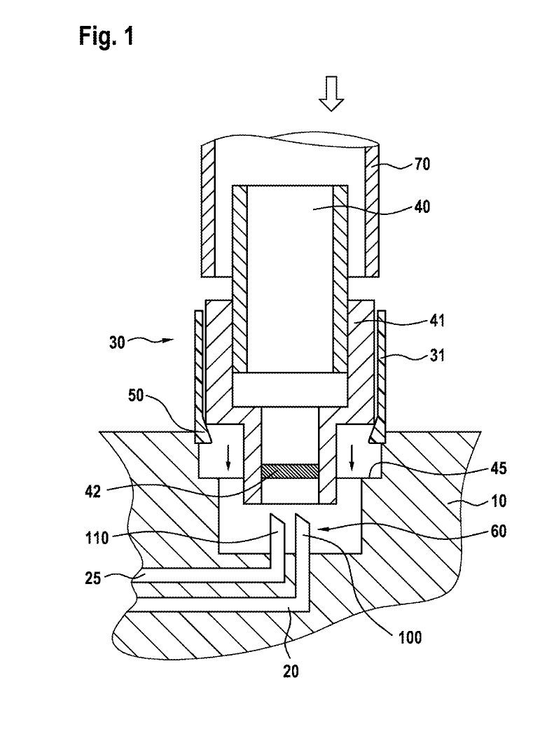

FIG. 1 shows a sectional view of a device for introducing a liquid sample (not illustrated) into a microfluidic system (not illustrated) according to a first embodiment of the present invention. The device has an adapter component 10 which is preferably formed by a multilayer structure (not illustrated). Thus, for example an upper component (not illustrated) and a lower component (not illustrated) are used, wherein ducts 20, 25, which are provided for fluidically connecting the adapter component 10 to the microfluidic system, are formed in between. The components can consist of polymers, for example of thermoplastic polymers, for example PC (polycarbonate), COC (cyclic olefin copolymer), COP (cyclic olefin polymer), PE (polyethylene) or PP (polypropylene). The underside of the lower component is structured for example by milling, hot embossing or injection-molding.

On its top side, the adapter component 10 has a receiving portion 30 which is formed substantially by a receiving element 31 and a protrusion 45 formed in the adapter component 10. The receiving portion 30 is intended to guide and receive a sample container 40 and has, at its lower end, a delimiting element 50 which is formed in the manner of an elastic lip which deforms elastically when subjected to a force. The delimiting element 50 serves to position the sample container 40 in a first predetermined receiving position after the sample container 40 has been inserted into the receiving portion 30, wherein the sample container 40 is received in the longitudinal direction of the receiving portion 30. FIG. 1 shows the sample container 40 in the first predetermined receiving position, in which the liquid patient sample is still stored inside the sample container 40 and it is not possible to remove it into the adapter component 10.

On its underside, the sample container 40 has a screw cap which cylindrically surrounds the region of the underside of the sample container 40. The screw cap 41 in turn has a septum 42 which is arranged in the central region of the screw cap 41. If the liquid sample inside the sample container 40 is now intended to be removed, the sample container 40 is transferred from the first predetermined receiving position to a second predetermined receiving position within the receiving portion 30 (see in this regard the two small arrows beneath the delimiting element 50 in FIG. 1), in which an opening element 60 arranged beneath the receiving portion 30 in the adapter component 10 pierces the sample container 40 such that the liquid sample in the sample container 40 is transferable into the duct 20. The second predetermined receiving position is defined by the protrusion 45, which comes into contact with the screw cap 41 in the second predetermined receiving position and thus acts as a stop for the sample container 40. It is not possible to insert the sample container 40 further into the adapter component 10 beyond the second predetermined receiving position.

Here, the opening element 60 is configured in the form of two hollow needles 100, 110 which are arranged inside the adapter component 10 in a fixed and spaced-apart manner. The sample container 40 is transferred from the first predetermined receiving position into the second predetermined receiving position with the aid of an external plunger 70, which is a constituent part of a diagnostic unit (not illustrated). A large arrow in the region of the plunger 70 indicates the direction of the effective force thereof on the sample container 40.

If the sample container 40 is moved further in the direction of the hollow needles 100, 110 from the first predetermined receiving position to the second predetermined receiving position, said hollow needles then pierce the septum 42 of the sample container 40, with the result that fluidic connections are established between the ducts 20, 25 and the inside of the sample container 40. In order to empty the sample container 40, a positive pressure, for example a pneumatic positive pressure, is applied to the duct 25, the feed duct, such that a positive pressure is generated in the sample container 40 via the hollow needle 110, said positive pressure causing the liquid sample present in the sample container 40 to flow out via the hollow needle 100 and the duct 20, the discharge duct. From the duct 20, the liquid sample passes for further processing into an attached LOC (not illustrated) of the microfluidic system.

The positive pressure in the feed duct 25 can be generated via a pump (not illustrated) which is arranged outside the adapter component 10, for example in the attached LOC or as an external component, for example as a syringe pump or peristaltic pump, and can be controlled via valves (not illustrated) arranged outside and/or inside the adapter component 10 and/or the LOC. The positive pressure is in the range from 10 to 2500 mbar and in this case preferably between 50 and 1000 mbar.

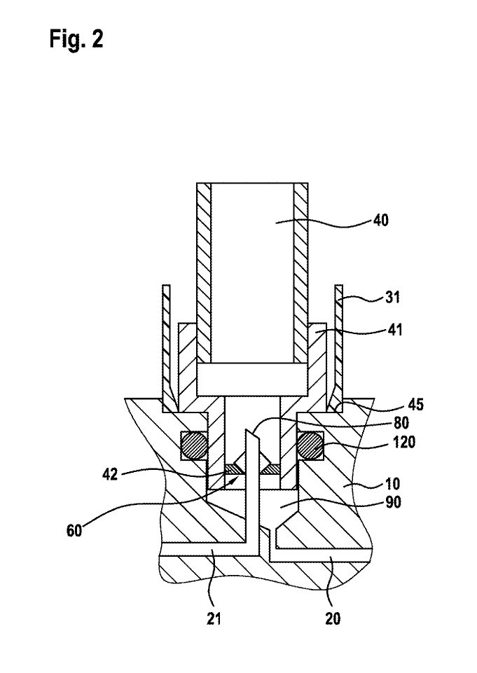

FIG. 2 shows a sectional view of a device for introducing a liquid sample (not illustrated) into a microfluidic system (not illustrated) according to a second embodiment of the present invention. The device likewise has an adapter component 10 which is preferably formed by a multilayer structure (not illustrated). The adapter component 10 illustrated in FIG. 2 corresponds substantially to the adapter component illustrated in FIG. 1, but the corresponding opening element 60 is formed in a different manner, and so only the structure thereof and the elements of the adapter component 10 that are functionally linked thereto are described in the following text.

FIG. 2 shows the sample container 40 in the second predetermined receiving position, in which the screw cap of the sample container 40 is in contact with the protrusion 45. Formed beneath the protrusion 45 is a seal 120 which executes a sealing function between the outer side of the screw cap 41 and the receiving portion 30 in the adapter component 10. A recess 90 in the adapter component 10 is formed in the region beneath the receiving portion 30, said recess 90 being fluidically connected to a duct 20. The duct 20 again acts as a discharge duct according to the embodiment in FIG. 1.

The opening element 60 is formed such that it at least partially slits open the sample container 40 while it is being transferred into the second predetermined receiving position, wherein the opening element 60 is formed integrally with a hollow needle 80. In this case, the opening element 60 is formed by a multiplicity of cutters which are arranged along the outer circumference of the hollow needle 80 substantially in the region of the top side thereof. The integrally formed opening element 60 is arranged substantially congruently with the longitudinal axis of the receiving portion 30. In terms of its function, the hollow needle 80 is designed analogously to the hollow needle 110 according to the embodiment in FIG. 1, i.e. in order to empty the sample container 40, a positive pressure, for example a pneumatic positive pressure, is applied to a duct 21, the feed duct, which is operatively connected to the hollow needle 80, such that a positive pressure is generated in the sample container 40 via the hollow needle 80, said positive pressure causing the liquid sample (not illustrated) located in the sample container 40 to flow out into the recess 90 via a further opening (not illustrated), which is created as a result of the septum 42 of the sample container 40 being slit open while the latter is being transferred into the second predetermined receiving position, and the duct 20, the discharge duct. In other words, the liquid sample is transferred into the recess from the sample container 40 in the second predetermined receiving position by a gaseous medium, in this case preferably air, being pumped through the hollow needle 80, with the result that the liquid sample is pushed out of the sample container 40 through the opening created by the opening element 60 and subsequently flows into the recess 90.

The opening element 60 and the hollow needle 80 are each configured in a substantially rotationally symmetrical manner, and, while the sample container 40 is being transferred from the first predetermined receiving position to the second predetermined receiving position, the hollow needle 80 first of all pierces the sample container 40 and subsequently the opening element 60 slits open the sample container 40.

According to the embodiment in FIG. 1, the sample container 40 can again be transferred from the first predetermined receiving position to the second predetermined receiving position with the aid of a plunger (not illustrated), or else by the sample container 40 being rotated or screwed in with the use of a bayonet closure (not illustrated) which is formed by the sample container 40 and the receiving portion 30.

1. A device for introducing a liquid sample into a microfluidic system, comprising:
an adapter component fluidically couplable to the microfluidic system via at least one duct, the adapter component having a receiving portion configured to guide and receive a sample container;
a delimiting element configured to position the sample container in a first predetermined receiving position after the sample container has been inserted into the receiving portion; and
an opening element arranged beneath the receiving portion in the adapter component, the opening element configured to pierce the sample container such that the liquid sample in the sample container is transferable into the at least one duct when the sample container is transferred from the first predetermined receiving position to a second predetermined receiving position within the receiving portion.

2. The device as claimed in claim 1, wherein the sample container is transferred from the first predetermined receiving position to the second predetermined receiving position within the receiving portion with the aid of an external plunger.

3. The device as claimed in claim 2, wherein the opening element is configured as a hollow needle and the at least one duct is fluidically connected to a second hollow needle that is arranged at a distance from the first hollow needle.

4. The device as claimed in claim 1, wherein the sample container is transferred from the first predetermined receiving position to the second predetermined receiving position within the receiving portion by rotation of the sample container.

5. The device as claimed in claim 4, wherein the opening element is configured to at least partially slit open the sample container while the sample container is being transferred into the second predetermined receiving position.

6. The device as claimed in claim 1, wherein the opening element is formed integrally with a hollow needle.

7. The device as claimed in claim 6, wherein the integrally formed opening element is arranged substantially congruently with the longitudinal axis of the receiving portion.

8. The device as claimed in claim 6, wherein the opening element and the hollow needle are each configured in a substantially rotationally symmetrical manner, and while the sample container is being transferred from the first predetermined receiving position to the second predetermined receiving position, the hollow needle pierces the sample container and then the opening element slits open the sample container.

9. The device as claimed in claim 4, wherein the sample container is rotated with the use of a bayonet closure that is formed by the sample container and the receiving portion.

10. The device as claimed in claim 6, wherein a recess in the adapter component configured to receive the liquid sample from the sample container is formed in the region of the opening element, the recess being fluidically connected to the at least one duct.

11. The device as claimed in claim 10, wherein the liquid sample is transferred from the sample container into the recess in the second predetermined receiving position by a gaseous medium being pumped through the hollow needle such that the liquid sample is pushed out of the sample container through the opening formed by the opening element and subsequently flows into the recess.
